(19) United States
(12) Patent Application Publication
(10) Pub. No.: US 2015/0140850 A1
(43) Pub. Date: May 21, 2015

(54) SHIELD CONNECTOR STRUCTURE

(71) Applicant: Yazaki Corporation, Tokyo (JP)

(72) Inventors: Takatoshi SUZUKI, Kakegawa-shi (JP); Naoki MATSUSHITA, Kakegawa-shi (JP)

(73) Assignee: Yazaki Corporation, Tokyo (JP)

(21) Appl. No.: 14/603,436

(22) Filed: Jan. 23, 2015

Related U.S. Application Data
(63) Continuation of application No. PCT/JP2013/070022, filed on Jul. 24, 2013.

(30) Foreign Application Priority Data
Jul. 25, 2012 (JP) 2012-164484

(51) Int. Cl. H01R 13/52

(52) U.S. Cl. CPC H01R 13/5219
USPC 439/275

(57) ABSTRACT

A shield connector structure includes: a connection member fixed to the outer surface of a metal case; a first seal member interposed between an inner surface of the connection member and an outer surface of an outer insulation coating of a shield wire; a second seal member interposed between the connection member and an inner surface of an insertion hole of the metal case; and an annular fixing member that fixes a shield portion of the shield wire to the connection member by crimping. The connection member includes a first cylindrical extension portion extending from the connection member body to the inside of the insertion hole of the metal case and a second cylindrical extension portion further extending from the tip of the first extension portion and having an outer diameter smaller than that of the first extension portion. The shield portion is clamped by the fixing member.

### TECHNICAL FIELD

The invention relates to a shield connector structure, and more particularly, to a shield connection structure for connecting a shield wire, which is inserted into an insertion hole from one side to the other side of a connection object, to the connection object.

### BACKGROUND ART

In the past, there has been proposed a shield connector structure for connecting devices, such as a motor, a battery, and an inverter, to one another by a shield wire in a vehicle (in particular, an electric vehicle or a hybrid vehicle) and grounding the shield wire and a case of the devices (e.g., refer to Patent Literature 1). As illustrated in FIG. 5, a shield connector structure 100 described in Patent Literature 1 is intended to connect a shield wire 1 and a metal case 6 of a connection object and to waterproof a connection portion. The shield wire 1 is a coaxial cable including a conductor 2, an inner insulation coating 3 that covers the periphery of the conductor 2, a shield portion 4 that includes a conductor such as a braid and provided around the inner insulation coating 3, and an outer insulation coating 5 that covers the periphery of the shield portion 4. The metal case 6 includes an insertion hole 7 into which the shield wire 1 is inserted, and a bolt hole 8 to which a bolt 106 for fixing a connection member 101 is screwed.

The shield connector structure 100 is configured by including the connection member 101 in which the shield wire 1 is inserted and which is fixed to the metal case 6, a shield member 102 that electrically connects the shield portion 4 of the shield wire 1 and the metal case 6, a first seal member 103 that is interposed between the inner surface of the shield member 102 and the outer surface of the outer insulation coating 5 of the shield wire 1, a second seal member 104 that is interposed between the outer surface of the shield member 102 and the inner surface of the insertion hole 7 of the metal case 6, a shield pipe 105 that is crimped to cover the shield portion 4 connected to the shield member 102, and the bolt 106 that fixes the connection member 101 to the metal case 6.

The connection member 101 is fixed to one side (outer side) of the metal case 6 and held with the shield member 102 interposed between the metal case 6 and the connection member 101, and is configured to include an insertion portion 111 for inserting the shield wire 1, a cylindrical protrusion portion 112 further extending to the other side (inner side) of the metal case 6 than the insertion portion 111 and inserted into the insertion hole 7, and a flange portion 113 extending radially outward from the insertion portion 111 and fixed to the metal case 6. The shield member 102 is configured to include a first cylindrical portion 121, a second cylindrical portion 122, and a third cylindrical portion 123, of which diameters are increased in three stages from the other side to one side of the metal case 6, and a flange-shaped portion 124 formed along one surface (outer surface) of the metal case 6 bent continuously to the third cylindrical portion 123. The first cylindrical portion 121 is connected to the shield portion 4 of the shield wire 1, and the flange-shaped portion 124 is interposed between one surface of the metal case 6 and the connection member 101. The shield portion 4 is grounded through the shield member 102 with respect to the metal case 6.

A first seal member 103 is formed by an elastic material such as a rubber in an entirely cylindrical shape. The first seal member 103 has concavo-convex annular lip portions on an inner peripheral surface thereof and an outer peripheral surface thereof. A plurality of lip portions on the inner peripheral surface is in close contact with the outer surface of the outer insulation coating 5 of the shield wire 1. A plurality of lip portions on the outer peripheral surface is in close contact with each inner surface of the second cylindrical portion 122 of the shield member 102 and the cylindrical protrusion portion 112 of the connection member 101. Therefore, a gap between the shield wire 1 and the shield member 102 and the connection member 101 is sealed. On the other hand, a second seal member 104 is formed by an elastic material such as a rubber in an entirely cylindrical shape. The second seal member 104 has two articles of lip portions on an inner peripheral surface thereof and an outer peripheral surface thereof. The lip portion on the inner peripheral surface is in close contact with the outer surface of the second cylindrical portion 122 of the shield member 102. The lip portion on the outer peripheral surface is in close contact with the inner surface of the insertion hole 7 of the metal case 6. Therefore, a gap between the shield member 102 and the metal case 6 is sealed. Also, the second seal member 104 is interposed and held between a rear edge of the shield pipe 105 and a stepped portion that makes the second cylindrical portion 122 and the third cylindrical portion 123 continuous in the shield member 102.

As described above, in the shield connector structure 100 of the related art described in Patent Literature 1, the shield wire 1 is mechanically connected to the metal case 6 by the connection member 101, and the shield portion 4 is electrically connected to the metal case 6 through the shield member 102. Furthermore, the sealing by the first seal member 103 and the second seal member 104 can achieve the waterproof in the connection portion between the shield wire 1 and the metal case 6, and can prevent water or the like from penetrating from the outside to the inside of the metal case 6.

### CITATION LIST

### Patent Literature

Patent Literature 1: JP 2000-294344 A

### SUMMARY OF INVENTION

### Technical Problem

However, in the shield connector structure of the related art, since the shield portion 4 of the shield wire 1 and the metal case 6 are grounded through the shield member 102, the number of parts is increased by the number of the shield members 102 and the number of assembling processes is also increased. Also, the shield member 102 may be formed by brass, which is an alloy of copper and zinc, and the metal case 6 may include an aluminum alloy. However, in a case where the shield member 102 made of brass composed of such dissimilar metals and the metal case 6 made of the aluminum alloy come into close contact with each other, a galvanic corrosion may occur and the shield member 102 may be fixated to the metal case 6. When such fixation occurs, the shield member 102 may be deformed when the shield wire 1 is removed from the metal case 6 at the time of the maintenance of the vehicle. Therefore, it is necessary to replace the shield member 102, which in turns requires significant time and effort for replacement. Also, since the shield member 102 of the related art is made of the metal such as the thin brass with low rigidity, there is also a problem of strength in that the shield member 102 is easily deformed at the time of disassembly maintenance. Furthermore, since the second seal member 104 is interposed and held between the rear edge of the shield pipe 105 and the stepped portion of the shield member 102, the second seal member 104 may be entered into the shield pipe 105, or the second seal member 104 may be damaged at the rear edge of the shield pipe 105. Hence, the waterproof performance may be degraded.

The invention has been made in view of the above-described points, and accordingly, it is an object of the invention to provide a shield connector structure capable of improving the workability of the disassembly maintenance and the waterproof performance.

### Solution to Problem

In order to solve the above problems, there is provided a shield connector structure according to a first aspect of the present invention, the shield connector structure for connecting a shield wire to a connection object by inserting the shield wire into an insertion hole of the connection object from one side to the other side, the shield wire including a conductor, an inner insulation coating, a shield portion, and an outer insulation coating, the shield connector structure including: a connection member into which the shield wire is inserted and which is fixed to one side of the connection object; a first seal member that is interposed between an inner surface of the connection member and an outer surface of the outer insulation coating of the shield wire; a second seal member that is interposed between the connection member and an inner surface of the insertion hole of the connection object; and an annular fixing member that fixes the shield portion of the shield wire to the connection member, wherein the connection member is formed by a metal material having conductivity, the connection member includes: a connection member body that is fixed to the connection object in contact with one surface of the connection object; a first cylindrical extension portion that extends from the connection member body to the inside of the insertion hole of the connection object; and a second cylindrical extension portion that extends from the first extension portion to the other side and has an outer diameter smaller than an outer diameter of the first extension portion, the shield portion of the shield wire is clamped by the fixing member from the outside in a radial direction so that the shield portion is fixed to the second extension portion, and the shield portion and the connection object are electrically connected through the connection member.

According to a second aspect of the present invention, there is provided the shield connector structure as described in the first aspect, wherein the second extension portion of the connection member is provided to protrude from the insertion hole of the connection object to the other side, and the shield portion of the shield wire is fixed to the protrusion position.

According to a third aspect of the present invention, there is provided the shield connector structure as described in the first or second aspect, wherein in the first extension portion of the connection member, a concave groove portion is formed along a circumferential direction such that the concave groove portion is recessed from an outer peripheral surface thereof, and the second seal member is held in the concave groove portion.

According to a fourth aspect of the present invention, there is provided the shield connector structure as described in any one of first to third aspects, wherein a large-diameter portion is formed in one side rather than the first extension portion of the connection member by expanding a diameter of the inner peripheral surface of the connection member body, and the first seal member is press-fitted between the large-diameter portion and the outer surface of the outer insulation coating of the shield wire.

### Advantageous Effects of Invention

According to the first aspect of the present invention, the second extension portion is formed in the connection member, and the shield portion of the shield wire is clamped from the outside in the radial direction by the fixing member so that the shield portion is fixed to the connection portion. The shield portion and the connection object are electrically connected through the connection member. Therefore, as opposed to the related art, the shield portion of the shield wire can be grounded without using the shield member. Therefore, the shield member can be omitted. The number of parts and the number of assembling processes can be reduced and the cost of the shield connector structure can be reduced. At this time, one surface of the connection object and the connection member body come into contact with the each other and are electrically connected to each other. However, since the connection object and the connection member are mutually fixed, the connection object and the connection member are members having a relatively high rigidity. The members are hardly deformed at the time of disassembly maintenance. Since the replacement of parts is not needed, the maintainability can be improved.

Also, the first seal member is provided between the inner surface of the connection member and the outer surface of the outer insulation coating of the shield wire. The second seal member is provided between the connection member and the inner surface of the insertion hole of the connection object. Each of the first seal member and the second seal member is provided in close contact with the connection member. Therefore, the waterproof structure can be simplified, thereby improving the waterproof performance, as compared with the case where the first seal member comes into close contact with even the shield member of the related art. Also, the second seal member is interposed between the outer surface of the connection member and the inner surface of the insertion hole of the connection object. This is not the configuration of the related art in which the second seal member abuts against the rear edge of the shield pipe. Therefore, misalignment or damage of the second seal member can be prevented, thereby reliably suppressing the degradation of the waterproof performance.

According to the second aspect of the present invention, the second extension portion of the connection member protrudes from the insertion hole of the connection object to the other side. The shield portion of the shield wire is fixed to the second extension portion at the protrusion position. In this manner, the protrusion length of the second extension portion can be secured to increase the fixing strength of the shield portion by the fixing member. Also, since the second extension portion protrudes from the insertion hole to the other side, the protrusion length of the first extension portion positioned within the insertion hole can be secured. The second seal member is interposed between the outer surface of the first extension portion and the inner surface of the insertion hole. Therefore, the waterproof performance at the position of the second seal member can be improved.

According to the third aspect of the present invention, the concave groove portion is formed in the first extension portion, and the second seal member is held to the concave groove portion. Therefore, misalignment of the second seal member can be reliably prevented, thereby further improving the waterproof performance. At this time, since the concave groove portion cannot come into line contact with the second seal member as in the rear edge of the shield pipe of the related art, the damage of the second seal member can be prevented and the degradation of the waterproof performance can be reliably prevented.

According to the fourth aspect of the present invention, the large-diameter portion is formed on the inner periphery of the connection member, and the first seal member is press-fitted between the large-diameter portion and the outer surface of the outer insulation coating of the shield wire. Therefore, the first seal member can be reliably press-fitted from one side of the connection member. The waterproof performance at the position of the first seal member can be improved. That is, when the first seal member is provided on the other side rather than the connection member body as in the related art, it is impossible to check the close contact state among the first seal member, the connection member, and the seal wire. On the other hand, in the configuration in which the first seal member is positioned at the opened large-diameter portion on one side rather than the first extension portion of the connection member, it is possible to check the close contact state of the first seal member, thereby securing the waterproof performance.

### BRIEF DESCRIPTION OF DRAWINGS

FIG. 1 illustrates a cross-sectional view of a shield connector structure according to an embodiment of the invention.

FIG. 2 illustrates a perspective view of a shield wire in the shield connector structure.

FIG. 3 illustrates a perspective view when the shield connector structure is viewed from one side of a connection object.

FIG. 4 illustrates a partial exploded cross-sectional view of the shield connector structure.

FIG. 5 illustrates a cross-sectional view of a shield connector structure according to the related art.

### DESCRIPTION OF EMBODIMENTS

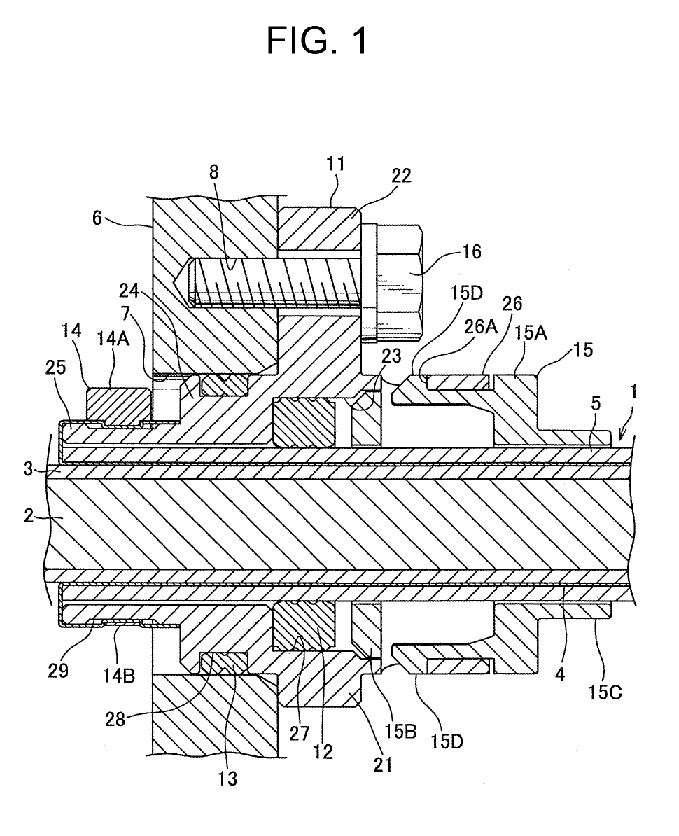

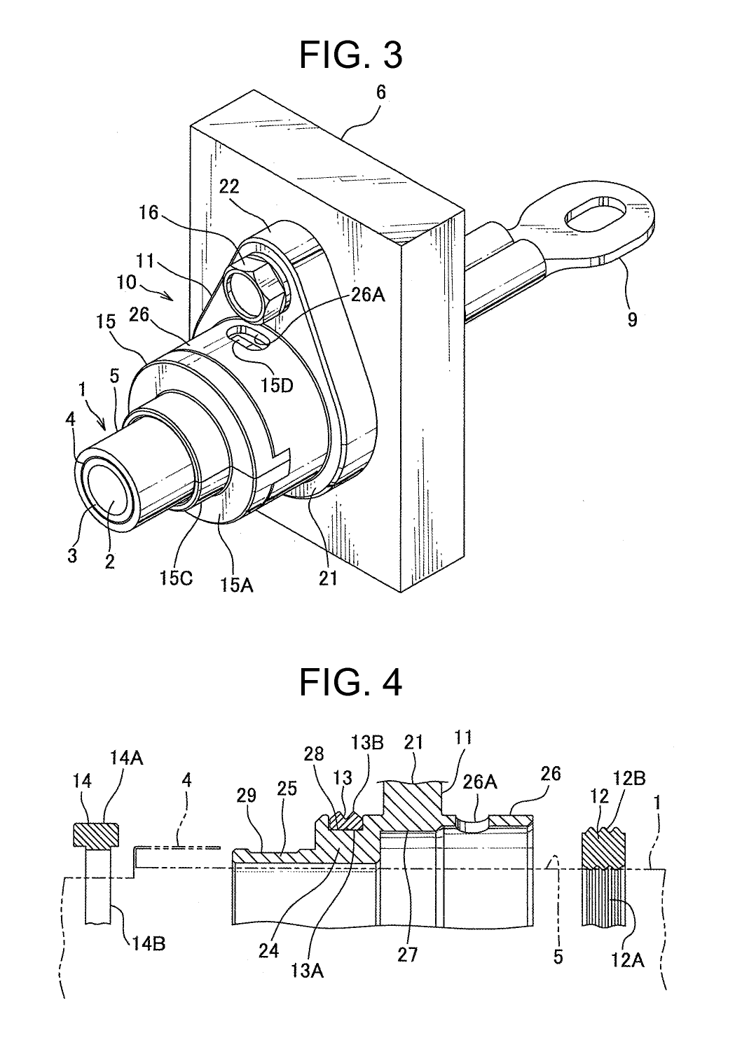

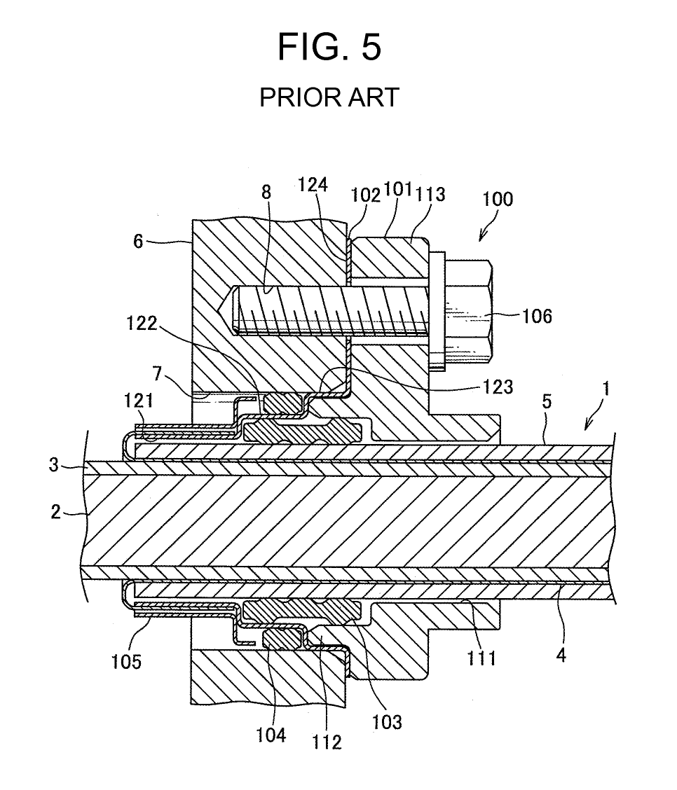

Hereinafter, a shield connector structure according to an embodiment of the invention will be described with reference to FIGS. 1 to 4. The shield connector structure according to the present embodiment is a connection structure suitable to ground a shield wire 1 and achieve waterproof of the connection portion in a case where the shield wire 1 couples a motor and an inverter or couples an inverter and a battery in a vehicle, in particular, an electric vehicle traveling by a driving force of an electric motor, or a hybrid vehicle traveling by a driving force of both an engine and an electric motor.

As illustrated in FIG. 1, the shield wire 1 is a coaxial cable that includes a conductor 2 including a twisted wire or the like provided by twisting a plurality of strands, an inner insulation coating 3 including an insulating synthetic resin to cover the periphery of the conductor 2, a shield portion 4 including a conductor such as a braid and provided around the inner insulation coating 3, and an outer insulation coating 5 including an insulating synthetic resin to cover the periphery of the shield portion 4. On the other hand, a motor, an inverter, or a battery as a connection object has a metal case 6 that constitutes an outer shell thereof. The metal case 6 is provided with an insertion hole 7 into which the shield wire 1 is inserted.

The shield wire 1 is inserted from the outer side (one side) to the inner side (the other side) of the metal case 6 through the insertion hole 7, and a terminal metal fitting 9 is fixed to the conductor 2 at the tip of the inner side. The terminal metal fitting 9 is connected to an electrical connection portion (not illustrated) of the metal case 6. Also, the shield portion 4 of the shield wire 1 is exposed by removing the outer insulation coating 5 from the tip thereof and is grounded to the metal case 6 through a connection member 11 to be described below. The shield portion 4 and the connection member 11 can shield an electromagnetic wave and can prevent a noise from leaking or penetrating from the connection portion.

The shield connector structure 10 is configured by including the connection member 11 into which the shield wire 1 is inserted and which is fixed to the outer surface (one surface) of the metal case 6, a first seal member 12 that is interposed between the inner surface of the connection member 11 and the outer surface of the outer insulation coating 5 of the shield wire 1, a second seal member 13 that is interposed between the connection member 11 and the inner surface of the insertion hole 7 of the metal case 6, an annular fixing member 14 that fixes the shield portion 4 of the shield wire 1 and the connection member 11 by crimping, a rear holder 15 made of a resin and attached to the outer side of the metal case 6 in the connection member 11, and a bolt 16 that fixes the connection member 11 to the metal case 6.

The connection member 11 is a die-cast part that is integrally made of a conductive metal such as an aluminum alloy. The connection member 11 is configured to include a connection member body 21 that is fixed in contact with the outer surface of the metal case 6, a fixing portion 22 that is fixed to the metal case 6 from the outside of the metal case 6, a wire guide portion 23 that inserts the shield wire 1 through the connection member body 21, a first extension portion 24 that is positioned to extend from the connection member body 21 to the inside of the insertion hole 7 of the metal case 6, a second cylindrical extension portion 25 that further extends from the tip of the first extension portion 24 and has an outer diameter smaller than an outer diameter of the first extension portion 24, and an outer cylindrical portion 26 that extends from the connection member body 21 to the outside of the metal case 6 and inserts the shield wire 1.

In the connection member 11, an opened large-diameter portion 27 is formed on the outer side. In the opened large-diameter portion 27, the inner diameter is expanded more than the first extension portion 24 and the second extension portion 25 in the wire guide portion 23 on the outer side of the metal case 6 than in the first extension portion 24. Also, in the first extension portion 24, a concave groove portion 28 is formed along a circumferential direction, such that the concave groove portion 28 is recessed from the outer peripheral surface thereof. In the second extension portion 25, a concave groove portion 29 is formed along a circumferential direction such that the concave groove portion 29 is recessed from the outer peripheral surface thereof.

As illustrated in FIG. 4, the first seal member 12 is configured to include an inner-peripheral close contact portion 12A that includes an elastic material such as a rubber in an entirely cylindrical shape and comes into close contact with the outer peripheral surface of the outer insulation coating 5 along the shield wire 1, and an outer-peripheral close contact portion 12B that comes into close contact with the inner peripheral surface of the large-diameter portion 27 in the connection member 11. Three articles of annular lips are formed in each of the inner-peripheral close contact portion 12A and the outer-peripheral close contact portion 12B. These annular lips are crushed and pressed against the outer peripheral surface of the outer insulation coating 5 or the inner peripheral surface of the large-diameter portion 27, and are sealed between the shield wire 1 and the connection member 11. The first seal member 12 is press-fitted and attached between the large-diameter portion 27 and the outer insulation coating 5 from the outer side of the metal case 6 toward the connection member 11 along the shield wire 1.

The second seal member 13 is configured to include an inner-peripheral close contact portion 13A that includes an elastic material such as a rubber in an entirely cylindrical shape and comes into close contact with the bottom surface of the concave groove portion 28 of the connection member 11, and an outer-peripheral close contact portion 13B that comes into close contact with the inner peripheral surface of the insertion hole 7 in the metal case 6. Two articles of annular lips are formed in each of the inner-peripheral close contact portion 13A and the outer-peripheral close contact portion 13B. These annular lips are crushed and pressed against the bottom surface of the concave groove portion 28 or the inner peripheral surface of the insertion hole 7, and are sealed between the connection member 11 and the metal case 6. The second seal member 13 is fitted and held to the concave groove portion 28 of the first extension portion 24 in the connection member 11.

The fixing member 14 includes a fixing member body 14A, and a strip-shaped band portion 14B that extends from the fixing member body 14A. The band portion 14B passes through the hole provided in the fixing member body 14A. The band portion 14B is locked by the locking claw inside the hole. The shield portion 4 of the shield wire 1 is clamped from the outside in the radial direction so that the shield portion 4 is fixed to the concave groove portion 29 of the second extension portion 25 in the connection member 11.

The rear holder 15 is configured to include a disk-shaped rear holder body 15A, an insertion portion 15B that extends from the rear holder body 15A and is inserted into the outer cylindrical portion 26 of the connection member 11, and a wire holding portion 15C that extends from the rear holder body 15A on an opposite side to the insertion portion 15B. The rear holder 15 is divided into two parts in the circumferential direction, is attached to the connection member 11 to interpose the shield wire 1, and is inserted into the outer cylindrical portion 26 of the connection member 11 such that the locking claw 15D provided in the insertion portion 15B is locked to the locking hole 26A of the outer cylindrical portion 26.

Next, an example of a procedure of assembling the shield wire 1 to the metal case 6 will be described. The procedure of assembling the shield wire 1 is not limited to that described below. After the assembling, the shield connector structure 10 illustrated in FIG. 1 may be configured, and thus, the following each procedure may be appropriately changed.

First, the shield portion 4 is exposed by peeling the outer insulation coating 5 at the tip of the shield wire 1 cut into a predetermined length, and the tip is inserted into the first seal member 12 and the connection member 11 in this order. Then, the first seal member 12 is moved toward the tip of the shield wire 1 and is press-fitted between the large-diameter portion 27 and the outer peripheral surface of the outer insulation coating 5. Therefore, the inner-peripheral close contact portion 12A of the first seal member 12 is brought into close contact with the outer insulation coating 5 of the shield wire 1, so that the outer-peripheral close contact portion 12B comes into close contact with the inner surface of the large-diameter portion 27.

Then, the shield portion 4 of the shield wire 1 is folded to overlap the second extension portion 25 of the connection member 11. The band portion 14B of the fixing member 14 overlapping the outer side of the shield portion 4 is locked to the fixing member body 14A and the band portion 14B is clamped so that the shield portion 4 is fixed to the connection member 11. Furthermore, the terminal metal fitting 9 is pressed against the conductor 2 exposed by peeling the inner insulation coating 3. Then, the second seal member 13 is fitted and held from the tip of the shield wire 1 to the concave groove portion 28 of the first extension portion 24. Furthermore, as described above, the rear holder 15 is attached to the outer cylindrical portion 26 of the connection member 11.

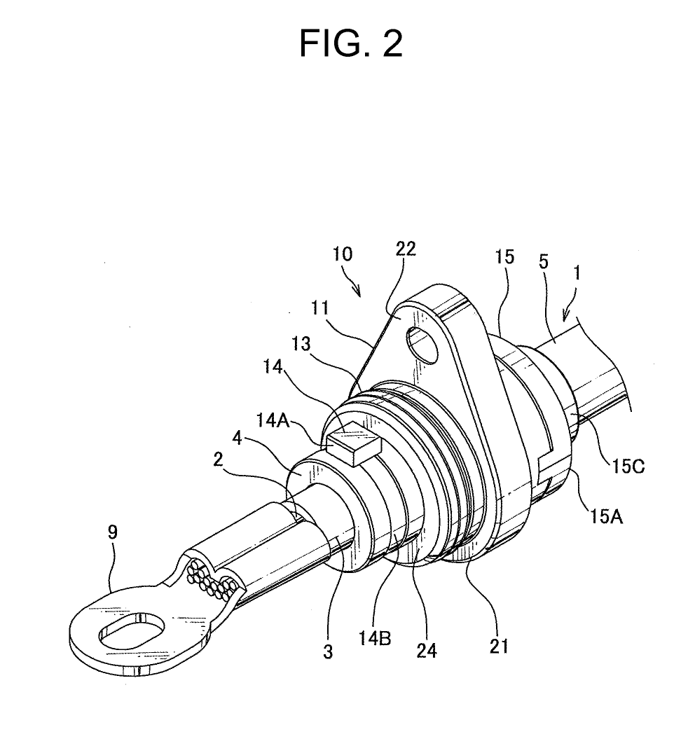

Therefore, as illustrated in FIG. 2, the connection member 11, the first seal member 12, the second seal member 13, the fixing member 14, and the rear holder 15 are attached to the tip of the shield wire 1. In this state, the shield wire 1 is inserted from the side of the terminal metal fitting 9 to the insertion hole 7 of the metal case 6. The shield wire 1 is pressed while the outer-peripheral close contact portion 13B of the second seal member 13 comes into slidable contact with the inner peripheral surface of the insertion hole 7, and the first extension portion 24 of the connection member 11 is inserted into the insertion hole 7. The connection member body 21 and the fixing portion 22 of the connection member 11 abut against the outer surface of the metal case 6. Then, the bolt 16 inserted into the fixing portion 22 of the connection member 11 is screwed to the bolt hole 8 of the metal case 6. In this manner, the assembly of the shield wire 1 is completed.

According to the present embodiment, the shield portion 4 of the shield wire 1 is clamped by the fixing member 14 so that the shield portion 4 is fixed to the second extension portion 25 of the connection member 11. The shield portion 4 and the metal case 6 are electrically connected through the connection member 11. Therefore, the shield member used in the related art can be omitted. Consequently, the number of parts and the number of assembling processes can be reduced and the cost of the shield connector structure 10 can be reduced. Also, since both the metal case 6 and the connection member 11 are made of the aluminum alloy, a galvanic corrosion hardly occurs and such fixation can be prevented. Since the metal case 6 and the connection member 11 are members having a relatively high rigidity, the metal case 6 and the connection member 11 are hardly deformed at the time of disassembly maintenance. Since the replacement of parts is not needed, the maintainability can be improved. Also, since each of the first seal member 12 and the second seal member 13 is provided to come into close contact with the connection member 11, the waterproof structure can be simplified, thereby improving the waterproof performance. Also, since the second seal member 13 is held to the concave groove portion 28 of the first extension portion 24, misalignment or damage of the second seal member 13 can be prevented, thereby reliably suppressing the degradation of the waterproof performance.

In the above embodiments, the coaxial cable has been taken as an example of the shield wire 1, but the invention can also be applied to a shield connector structure in a case where a shield wire having a conductor including a plurality of cores is connected. In this case, the first seal member or the second seal member, the first and second extension portions of the connection member, and the like may be formed to have an oval cross-section or an oval cylindrical cross-section. Also, the connection object is not limited to the motor, the inverter, or the battery used in the electric vehicle or the hybrid vehicle, and may be other appropriate electric devices or an electrical connection box in which electrical components are provided therein. Also, the object to ground the shield wire is not limited to the metal case 6 and may be a portion provided for the ground connection.

### REFERENCE SIGNS LIST

1 shield wire
2 conductor
3 inner insulation coating
4 shield portion
5 outer insulation coating
6 metal case (connection object)
7 insertion hole
10 shield connector structure
11 connection member
12 first seal member
13 second seal member
14 fixing member
21 connection member body
24 first extension portion
25 second extension portion
27 large-diameter portion
28 concave groove portion

1. A shield connector structure for connecting a shield wire to a connection object by inserting the shield wire into an insertion hole of the connection object from one side to the other side, the shield wire including a conductor, an inner insulation coating, a shield portion, and an outer insulation coating, the shield connector structure comprising:
a connection member in which the shield wire is inserted and which is fixed to one side of the connection object;
a first seal member that is interposed between an inner surface of the connection member and an outer surface of the outer insulation coating of the shield wire;
a second seal member that is interposed between the connection member and an inner surface of the insertion hole of the connection object; and
an annular fixing member that fixes the shield portion of the shield wire to the connection member, wherein
the connection member is formed by a metal material having conductivity,
the connection member includes:
a connection member body that is fixed to the connection object in contact with one surface of the connection object;
a first cylindrical extension portion that extends from the connection member body to the inside of the insertion hole of the connection object; and
a second cylindrical extension portion that extends from the first extension portion to the other side and has an outer diameter smaller than an outer diameter of the first extension portion, and
wherein
the fixing member includes a strip-shaped band portion, and
an outer periphery of the shield portion of the shield wire is wound by the band portion, and the shield portion is clamped by the fixing member from the outside in a radial direction in a manner to reduce a size of the band portion in a circumferential direction so that the shield portion is fixed to the second extension portion, and the shield portion and the connection object are electrically connected through the connection member.

2. The shield connector structure according to claim 1, wherein the second extension portion of the connection member is provided to protrude from the insertion hole of the connection object to the other side, and the shield portion of the shield wire is fixed to the protrusion position.

3. The shield connector structure according to claim 1, wherein in the first extension portion of the connection member, a concave groove portion is formed along a circumferential direction such that the concave groove portion is recessed from an outer peripheral surface thereof, and the second seal member is held in the concave groove portion.

4. The shield connector structure according to claim 2, wherein in the first extension portion of the connection member, a concave groove portion is formed along a circumferential direction such that the concave groove portion is recessed from an outer peripheral surface thereof, and the second seal member is held in the concave groove portion.

5. The shield connector structure according to claim 1, wherein a large-diameter portion is formed in one side rather than the first extension portion of the connection member by expanding a diameter of the inner peripheral surface of the connection member body, and the first seal member is press-fitted between the large-diameter portion and the outer surface of the outer insulation coating of the shield wire.

6. The shield connector structure according to claim 2, wherein a large-diameter portion is formed in one side rather than the first extension portion of the connection member by expanding a diameter of the inner peripheral surface of the connection member body, and the first seal member is press-fitted between the large-diameter portion and the outer surface of the outer insulation coating of the shield wire.

7. The shield connector structure according to claim 3, wherein a large-diameter portion is formed in one side rather than the first extension portion of the connection member by expanding a diameter of the inner peripheral surface of the connection member body, and the first seal member is press-fitted between the large-diameter portion and the outer surface of the outer insulation coating of the shield wire.

8. The shield connector structure according to claim 4, wherein a large-diameter portion is formed in one side rather than the first extension portion of the connection member by expanding a diameter of the inner peripheral surface of the connection member body, and the first seal member is press-fitted between the large-diameter portion and the outer surface of the outer insulation coating of the shield wire.
